(19) United States
(12) Patent Application Publication
(10) Pub. No.: US 2014/0111802 A1
(43) Pub. Date: Apr. 24, 2014

(54) LOW STRAY LIGHT POLYCHROMATOR

(71) Applicant: Jiangen Pan, Zhejiang (CN)

(72) Inventor: Jiangen Pan, Zhejiang (CN)

(73) Assignee: EVERFINE PHOTO-E-INFO CO., LTD., Zhejiang (CN)

(21) Appl. No.: 14/119,031

(22) PCT Filed: Feb. 14, 2012
(86) PCT No.: PCT/CN2012/071093

§ 371 Date: Nov. 20, 2013

(30) Foreign Application Priority Data
Jan. 19, 2012 (CN) 201210015681.X

(51) Int. Cl. G01J 3/36

(52) U.S. Cl. CPC G01J 3/36
USPC 356/328

(57) ABSTRACT

The invention discloses a low stray light polychromator comprising an optical housing, an entrance slit, a dispersion system and an array detector. The dispersion element of the dispersion system is a grating. A photosurface of the array detector is obliquely intersected with a principal section of the grating. In the invention, by changing the relative operation of optical elements in the polychromator, the stray light generated by the unexpected reflection on the photosurface of the array detector is exactly reflected out from the expected optical path. In addition, on the inner wall of the optical housing, small diaphragms for extinction are disposed in a plane in which reflection faculaee are projected, thus stray light will be reduced greatly.

### TECHNICAL FIELD

The invention relates to a device of spectral radiance measurement and spectral analysis, particularly to a low stray light polychromator.

### BACKGROUND OF THE INVENTION

A polychromator generally comprises an optical housing, an entrance slit, a dispersion system and an array detector. The beams of light enter the optical housing of the polychromator from the entrance slit and are then dispersed by a dispersion element to form dispersed light with different wavelength. Then, the dispersed light is projected on the photosurface of an array detector to realize spectrum distribution measurement. All the abnormal radiations in optical systems are called “stray light”. The stray light of a polychromator includes the overlap of various diffraction orders and unexpected reflections. The intensity of stray light is a crucial technique specification of a polychromator.

The stray light caused by the overlap of various diffraction orders may be filtered by a filter, while the stray light caused by the unexpected reflected light is hard to eliminate. The unexpected reflected light is generated between all optical elements in the optical housing and between the optical elements and the optical housing. Especially on the photosurface of the array detector, due to a small incident angle of the dispersed light, the first reflected light is likely to return to the dispersion system to bring considerable stray light. Besides, the unexpected reflected light through the reflection on the optical housing wall also may enter the expected optical path, thus bringing stray light.

### SUMMARY OF THE INVENTION

In view of the above deficiencies in the prior art, an object of the invention is to provide a polychromator to overcome the problem in the prior art that a part of stray light is hard to eliminate.

To achieve the above purpose, the following technical solutions are employed in the invention.

A low stray light polychromator is provided, comprising an optical housing, an entrance slit, a dispersion system and an array detector, characterized in that the dispersion element of the dispersion system is a grating, and a photosurface of the array detector is obliquely intersected with a principal section of the grating.

The principal section of the grating is a plane perpendicular to a grating groove.

In an existing polychromator, the photosurface of the array detector is perpendicular to the principal section of the grating, so the light is likely to bring unexpected reflection on the photosurface of the array detector and then enters the expected optical path to result in stray light. In view of this problem on stray light, in the invention, the photosurface of the two-dimensional array detector departs from the vertical plane of the principal section of the grating by changing the relative position of optical elements in the polychromator, so that the light in the unexpected optical path resulting in stray light is reflected out from the expected optical path, thus the stray light is reduced.

The invention may be further defined and improved by the following technical characteristics.

The photosurface of the array detector departs a certain angle from the vertical plane of the principal section of the grating. According to the relative position of optical elements, the angle may be 2-12°, so that the reflection faculae, resulting from the specular reflection on the photosurface of the array detector, depart from the optical elements in the polychromator and exactly fall into a plane on the inner wall of the optical housing, thereby preventing the first reflected light of the array detector from entering the dispersion system, thus the stray light is reduced. Preferably, the angle between the photosurface of the array detector and the vertical plane of the principal section of the grating is 3-10°. Larger angle influences compactness of the optical elements in the polychromator, while smaller angle requires high high mechanical process.

A filter is disposed on an optical path between the dispersion system and the array detector and obliquely intersected with the principal section of the grating. The filter can allow, limit or prevent various lights, and may pass a certain wavelength range of wave band selectively and eliminate the overlap of grating spectrum orders. The filter is obliquely intersected with the principal section of the grating. The angle between the filter and the vertical plane of the principal section of the grating is 2-12°, so the unexpected light generated by the reflection on the surface of the filter is reflected out from the expected optical path exactly, thereby reducing the influence of the stray light. Preferably, the angle between the filter and the vertical plane of the principal section of the grating is 3-10°. Within this angle range, the optical elements in the optical housing of the polychromator are just arranged compactly.

Small diaphragms are mounted at equal intervals in a plane in which the reflection faculae are projected on the inner wall of the optical housing. The inner wall of the optical housing and the surfaces of the small diaphragms are uniformly painted with low-reflectance diffuse reflection material. The mounting of the small diaphragms may increase the number of times of reflection of the unexpected light on the surface of the optical housing, thereby greatly reducing the intensity of the unexpected light, so that light is absorbed, and the stray light resulted from the reflection of the reflection faculae on the inner wall of the optical housing is reduced or eliminated.

The plane with the small diaphragms provided therein on the inner wall of the optical housing and the surface of the small diaphragms may be uniformly painted with diffuse reflection material with a certain specular reflectance. In this case, on the optical path between the dispersion system and the array detector, a large diaphragm is placed in front of the photosurface of the detector in order to eliminate the stray light resulted from the reflection on both the inner wall of the optical housing and the small diaphragms. The combination of the small diaphragms and the large diaphragm may eliminate the stray light resulted from the reflection faculae generated by the photosurface of the detector.

The dispersion system comprises a collimation element, a dispersion element and a focus element. The collimation element transforms incident light into collimated light. With the dispersion function, the dispersion element, such as prism and grating, may disperse the incident light beams into light of different wavelength. The focus element focuses the expected collimated light beams from the dispersion element on the photosurface of the two-dimensional array detector.

The dispersion element may be a plane grating. In this case, the collimation element, the plane grating and the focus element form the dispersion system. The dispersion element may also be a concave grating that is a reflective diffraction grating formed by carving a series of parallel lines on the concave surface of a high-reflectance metal and that has functions of both dispersion and focus. The concave grating, the entrance slit and the array detector form the polychromator.

The array detector may be a one-dimensional array detector or two-dimensional array detector. The two-dimensional array detector can measure and analyze spectrum more precisely and improve the drawing efficiency of the spectrum.

The invention has the following advantages that: by changing the relative position of optical elements in the polychromator, the stray light generated by the unexpected reflection on the photosurface of the array detector is exactly reflected out from the expected optical path. In addition, on the inner wall of the optical housing, small diaphragms for extinction are mounted in a plane in which the reflection faculae are projected, thus the stray light will be reduced greatly.

### BRIEF DESCRIPTION OF THE DRAWINGS

FIG. 1 is a structure diagram of Embodiment 1 in the invention;

FIG. 2 is a structure diagram of Embodiment 1 in the invention;

FIG. 3 is a structure diagram of Embodiment 2 in the invention; and

FIG. 4 is a structure diagram of Embodiments 1 and 2 in the invention.

### DETAILED DESCRIPTION OF THE INVENTION

### Embodiment 1

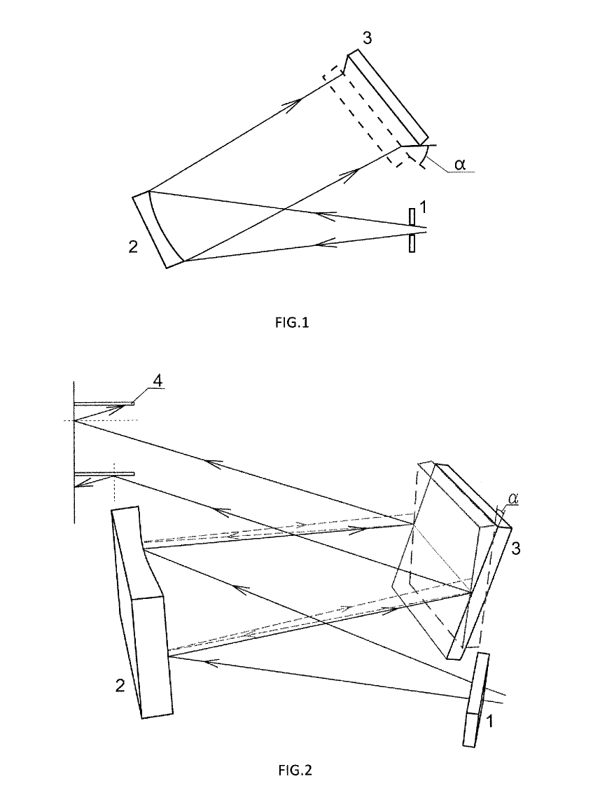

As shown in FIG. 1 and FIG. 2, a low stray light polychromator is provided, comprising an optical housing, an entrance slit 1, a dispersion system 2 and an array detector 3. The dispersion element 2 in this embodiment is a concave grating, and the array detector 3 is a two-dimensional array detector. In this embodiment, x-axis and z-axis are defined so that when the photosurface of the two-dimensional array detector 3 is perpendicular to the principal section of the grating 2, the axis passing through the center of the two-dimensional array detector 3 to be parallel to the intersection line of the principal section of the grating 2 and the photosurface of the two-dimensional array detector 3 is the z-axis, while the axis passing through the center of two-dimensional array detector 3 to be perpendicular to the intersection line of the principal section of grating 2 and the photosurface of the two-dimensional array detector 3 is the x-axis.

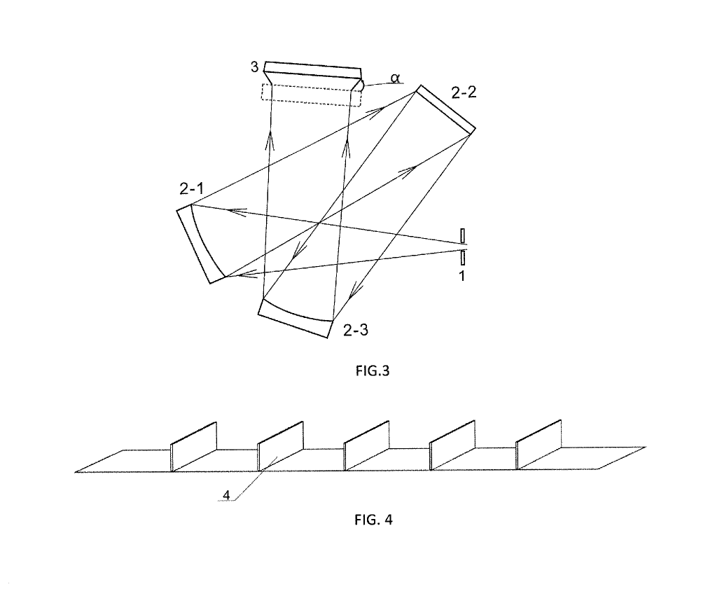

The incident light from the entrance slit 1 will be dispersed and focused by the dispersion system 2 and then projected on the photosurface of the two-dimensional array detector 3. The photosurface of the two-dimensional array detector 3 rotates around the z-axis by an angle α, and then departs from the vertical plane of the principal section of the grating 2. The included angle α is 10°. As shown in FIG. 1 and FIG. 2, dash lines show the position of the detector before rotation, while solid lines show the position of the detector after rotation. Before the detector rotates, the light on the photosurface of the two-dimensional array detector 3 from the dispersion system 2 yields the first reflected light that enters the optical path again and is projected on the photosurface of the two-dimensional array detector again by the dispersion system 2, thereby resulting in the stray light. The optical path of the stray light is shown as the dash lines with arrowhead in FIG. 2. After the detector rotates, the reflection faculae generated by the reflection of the light on the photosurface of the two-dimensional array detector 3 from the dispersion system 2 depart from the optical element in the optical housing, and are then projected on the inner wall of the optical housing. As shown in FIG. 4, small diaphragms 4 for extinction are disposed at equal intervals on the projection plane of the reflection faculae. Both the inner wall of the optical housing and the surface of the small diaphragms 4 are uniformly painted with low-reflectance diffuse reflection material. As shown in FIG. 2, the reflection faculae are reflected repeatedly by the inner wall of the optical housing and the small diaphragms 4, so the optical radiation energy thereof is reduced greatly and the stray light caused by the repeated reflection is thus reduced.

### Embodiment 2

As shown in FIG. 3, a low stray light polychromator is provided, comprising an optical housing, an entrance slit 1, a dispersion system 2 and an array detector 3. The dispersion system 2 in this embodiment comprises a collimation element 2-1, a dispersion element 2-2 and a focus element 2-3. The dispersion element 2-2 is a plane grating, and the array detector 3 is a two-dimensional array detector. In this embodiment, x-axis and z-axis are defined so that when the photosurface of the two-dimensional array detector 3 is perpendicular to the principal section of the grating 2, the axis passing through the center of two-dimensional array detector 3 to be parallel to the intersection line of the principal section of the grating 2 and the photosurface of the two-dimensional array detector 3 is the z-axis, while the axis passing through the center of the two-dimensional array detector 3 to be perpendicular to the intersection line of the principal section of grating 2 and the photosurface of the two-dimensional array detector 3 is the x-axis.

The incident light from the entrance slit 1 will be turned into parallel light by the collimation element 2-1, and then dispersed into light of different wavelength by the dispersion element 2-2. The expected parallel light from the dispersion element 2-1 will be focused onto the photosurface of the two-dimensional array detector 3 by the focus element 2-3. The photosurface of the two-dimensional array detector 3 rotates around the z-axis by an angle α, and then departs from the vertical plane of the principal section of the grating 2. The included angle α is 10°. The reflection faculae generated by the reflection of the light on the photosurface of the two-dimensional array detector 3 from the dispersion system 2 are projected in the plane in which the inner wall of the optical housing contained. As shown in FIG. 4, small diaphragms 4 for extinction are disposed at equal intervals in the projection plane of the reflection faculae.

1. A low stray light polychromator, comprising an optical housing, an entrance slit (1), a dispersion system (2) and an array detector (3), characterized in that the dispersion element of the dispersion system (2) is a grating (2-2), and a photosurface of the array detector (3) is obliquely intersected with a principal section of the grating (2-2).

2. The low stray light polychromator according to claim 1, characterized in that a filter is provided on an optical path between the dispersion system (2) and the array detector (3), and the filter is obliquely intersected with the principal section of the grating (2-2).

3. The low stray light polychromator according to claim 1, characterized in that a deviation angle between the photosurface of the array detector (3) and the vertical plane of the principal section of the grating is 2-12°.

4. The low stray light polychromator according to claim 3, characterized in that the reflected faculae, resulting from the specular reflection on the photosurface of the array detector (3) of the light dispersed onto the array detector (3) by the dispersion system (2), depart from the optical elements in the optical housing of the polychromator.

5. The low stray light polychromator according to claim 1, characterized in that small diaphragms (4) are mounted on the inner wall of the optical housing.

6. The low stray light polychromator according to claim 4, characterized in that, in the optical housing, the small diaphragms (4) are mounted in a plane in which the reflection faculae of the array detector (3) are projected.

7. The low stray light polychromator according to claim 1, characterized in that the inner wall of the optical housing is uniformly painted with low-reflectance diffuse reflection material.

8. The low stray light polychromator according to claim 6, characterized in that both the plane with the small diaphragms (4) provided therein and the small diaphragms (4) are uniformly painted with diffuse reflection material with a certain specular reflectance.

9. The low stray light polychromator according to claim 1, characterized in that the dispersion element (2-2) is a concave grating or a plane grating.

10. The low stray light polychromator according to claim 1, characterized in that the array detector (3) is a one-dimensional array detector or two-dimensional array detector.
